(19) United States
(12) Patent Application Publication
(10) Pub. No.: US 2023/0049554 A1
(43) Pub. Date: Feb. 16, 2023

(54) NETWORK SLICE SELECTION METHOD AND APPARATUS, DEVICE AND STORAGE MEDIUM

(71) Applicant: Tencent Technology (Shenzhen) Company Limited, Shenzhen (CN)

(72) Inventor: Yixue LEI, Shenzhen (CN)

(73) Assignee: Tencent Technology (Shenzhen) Company Limited, Shenzhen (CN)

(21) Appl. No.: 17/980,448

(22) Filed: Nov. 3, 2022

Related U.S. Application Data
(63) Continuation of application No. PCT/CN2021/130916, filed on Nov. 16, 2021.

(30) Foreign Application Priority Data
Dec. 16, 2020 (CN) 202011490260.3

(51) Int. Cl. H04W 48/18; H04W 28/24; H04W 36/08; H04L 41/0893

(52) U.S. Cl. CPC H04W 48/18; H04W 28/24; H04W 36/08; H04L 41/0893

(57) ABSTRACT

A network slice selection method includes, in response to an update in configuration information of a user of a media service, determining first information indicating updated configuration information of the user of the media service. The first information indicates an updated selection of a first network slice from at least two network slices. The method further includes transmitting, by the media service, the first information to an entity of a 5G Core network.

### RELATED APPLICATIONS

This application is a continuation of International Application No. PCT/CN2021/130916, entitled “NETWORK SLICE SELECTION METHOD AND APPARATUS, DEVICE AND STORAGE MEDIUM” and filed on Nov. 16, 2021, which claims priority to Chinese Patent Application No. 202011490260.3, entitled “NETWORK SLICE SELECTION METHOD AND APPARATUS, DEVICE AND STORAGE MEDIUM” and filed on Dec. 16, 2020. The entire disclosures of the prior applications are hereby incorporated by reference.

### FIELD OF THE TECHNOLOGY

Embodiments of this application relate to the field of mobile communications, including a network slice selection method and apparatus, a device and a storage medium.

### BACKGROUND OF THE DISCLOSURE

Network slice is a term newly introduced in the 5th Generation mobile network (5G) system. A network slice is a logical network serving a specific service or customer requirement.

Subscription information is used between a user and a Mobile Network Operator (MNO) to control which network slices User Equipment (UE) can access and which network slices can be accessed preferentially. The subscription information is parameter information subscribed between the user and the MNO and related to the use of a mobile network, including, for example, a code number, a key, and an International Mobile Subscriber Identity (IMSI).

In a process of using the UE by the user, which network slices are accessed is determined on the basis of the subscription information. Therefore, a third-party service platform cannot directly control the UE to access particular network slices.

### SUMMARY

This disclosure provides a network slice selection method and apparatus, a device and a storage medium. A third-party service platform may perform information interaction with a core entity on the basis of configuration information of a user, so as to select a first network slice, accessed by a User Equipment (UE), from at least two network slices.

In an embodiment, a network slice selection method includes, in response to an update in configuration information of a user of a media service, determining first information indicating updated configuration information of the user of the media service. The first information indicates an updated selection of a first network slice from at least two network slices. The method further includes transmitting, by the media service, the first information to an entity of a 5G Core network.

In an embodiment, a network slice selection method includes receiving, by an entity of a 5G Core network, first information transmitted by a media service, the first information being determined by the media service according to updated configuration information of a user of the media service. The method further includes selecting, by the entity of the 5G Core network based on the first information, a first network slice for providing the media service to the user from at least two network slices.

In an embodiment, a network slice selection apparatus includes processing circuitry of a media service, the processing circuitry being configured to, in response to an update in configuration information of a user of the media service, determine first information indicating updated configuration information of the user of the media service, the first information indicating an updated selection of a first network slice from at least two network slices. In response to the update in configuration information of the user of the media service, the processing circuitry is further configured to transmit the first information to an entity of a 5G Core network.

First information is determined through a third-party service entity on the basis of configuration information of a user; the first information is transmitted to a core entity; and the core entity selects a first network slice corresponding to the third-party service from at least two network slices, so that the third-party service entity can actively control a network slice accessed by a UE. A network slice management mechanism friendly to a third party is provided, so that the third party can flexibly provide different Quality of Service (QoS) levels for the user on the basis of the configuration information of the user, and the complexity of interaction between the third party and a mobile network operator is simplified.

### BRIEF DESCRIPTION OF THE DRAWINGS

FIG. 1 shows a structural block diagram of a communication system provided according to an exemplary embodiment of this disclosure;

FIG. 2 shows a structural block diagram of a communication system provided according to an exemplary embodiment of this disclosure;

FIG. 3 shows a schematic diagram of deployment of a network slice provided according to another exemplary embodiment of this disclosure;

FIG. 4 shows a schematic diagram of deployment of a user plane provided according to another exemplary embodiment of this disclosure;

FIG. 5 shows a schematic diagram of deployment of a control plane provided according to another exemplary embodiment of this disclosure;

FIG. 6 shows a flow chart of a network slice selection method provided according to one exemplary embodiment of this disclosure;

FIG. 7 shows a flow chart of a network slice selection method provided according to one exemplary embodiment of this disclosure;

FIG. 8 shows a schematic interface diagram of a network slice selection method provided according to one exemplary embodiment of this disclosure;

FIG. 9 shows a schematic interface diagram of a network slice selection method provided according to one exemplary embodiment of this disclosure;

FIG. 10 shows a flow chart of a network slice selection method provided according to one exemplary embodiment of this disclosure;

FIG. 11 shows a flow chart of a network slice selection method provided according to one exemplary embodiment of this disclosure;

FIG. 12 shows a flow chart of a network slice selection method provided according to one exemplary embodiment of this disclosure;

FIG. 13 shows a flow chart of a network slice selection method provided according to one exemplary embodiment of this disclosure;

FIG. 14 shows a flow chart of a network slice selection method provided according to one exemplary embodiment of this disclosure;

FIG. 15 shows a flow chart of a network slice selection method provided according to one exemplary embodiment of this disclosure;

FIG. 16 shows a flow chart of a network slice selection method provided according to one exemplary embodiment of this disclosure;

FIG. 17 shows a block diagram of a network slice selection apparatus according to one exemplary embodiment of this disclosure;

FIG. 18 shows a block diagram of a network slice selection apparatus according to one exemplary embodiment of this disclosure; and

FIG. 19 shows a block diagram of a network element device provided according to one exemplary embodiment of this disclosure.

### DESCRIPTION OF EMBODIMENTS

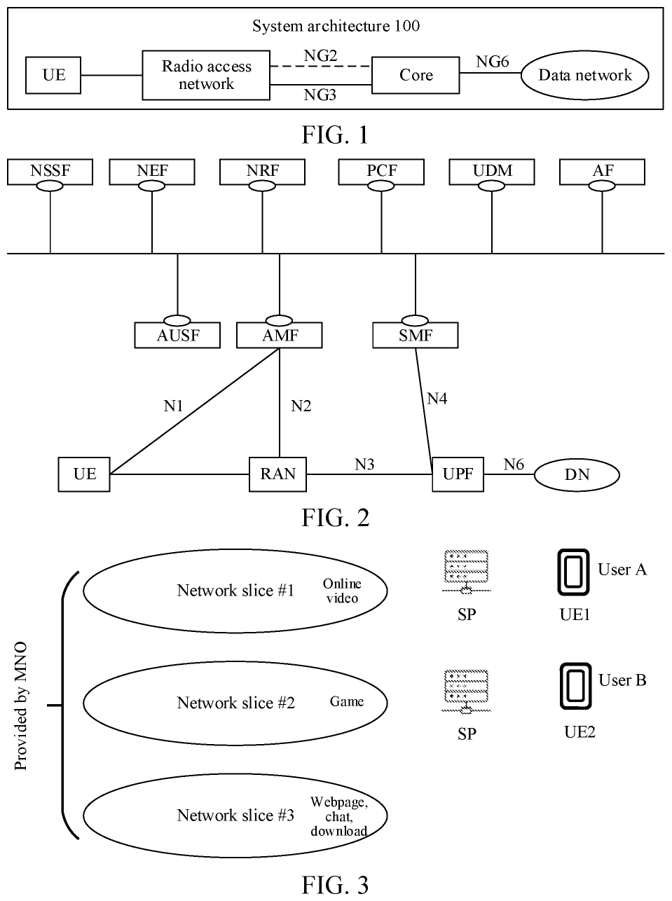

FIG. 1 is a schematic architecture diagram of a communication system provided according to an exemplary embodiment of this disclosure. As shown in FIG. 1, the system architecture 100 may include: a UE, a Radio Access Network (RAN), a core, and a Data Network (DN). The UE, the RAN, and the core are main components of the architecture, which can be logically divided into two parts: a user plane and a control plane. The control plane is responsible for the management of mobile networks, and the user plane is responsible for the transmission of business data. In FIG. 1, reference point NG2 is positioned between the RAN control plane and the core control plane; reference point NG3 is positioned between the RAN user plane and the core user plane; and reference point NG6 is positioned between the core user plane and a data network.

UE: It is an entry for mobile users to interact with a network. The UE can provide basic computing and storage capabilities, display business windows to users, and receive user operation inputs. The UE will use a next-generation new wireless technology to establish a signal connection and a data connection with the RAN, thereby transmitting control signals and service data to the mobile network.

RAN: It is similar to a base station in aa traditional network. The RAN is deployed close to the UE, provides a network access function for authorized users in a specific region, and can transmit user data using transmission tunnels with different qualities according to users' levels and service requirements. The RAN can manage its own resources, utilize them rationally, provide access services for the UE on demand, and forward the control signals and the user data between the UE and the core.

Core: It is responsible for maintaining subscription data of the mobile network, managing the network elements of the mobile network, and providing functions such as session management, mobility management, policy management, and security authentication for the UE. When the UE is attached, the core provides network access authentication for the UE. When the UE has a service request, the core allocates network resources to the UE. When the UE moves, the core updates network resources for the UE. When the UE is idling, the core provides a quick recovery mechanism for the UE. When the UE is detached, the core releases network resources for the UE. When the UE has service data, the core provides a data routing function for the UE, such as forwarding uplink data to the DN, or receiving UE downlink data from the DN, forwarding the data to the RAN, and then sending the data to the UE.

DN: It is a data network that provides business services for users. Generally, a client is positioned in the UE, and a server is located in the data network. The data network can be a private network, such as a local area network, or an external network that is not controlled by an operator, such as the Internet, or a private network jointly deployed by the operator, for example, in order to configure IP multimedia core network subsystem (IMS) services.

Network slice: It is a term newly introduced in a 5G network. A network slice is a logical network serving a specific business or customer requirement. Specifically, the network slice is formed through selection, configuration, and composition of functions in a service-based architecture. Multiple network slices will run on a common, infrastructural physical core and wireless network, but from the perspective of end-user applications, the network slices will appear to be running on separate networks.

FIG. 2 is a detailed architecture determined on the basis of FIG. 1. The core user plane includes a user plane function (UPF). The core control plane includes an Authentication Server Function (AUSF), an Access and Mobility Management Function (AMF), a Session Management Function (SMF), a Network Slice Selection Function (NSSF), a Network Exposure Function (NEF), a Network Function Repository Function (NRF), a Unified Data Management (UDM), a Policy Control Function (PCF), and an Application Function (AF). The functions of these functional entities are as follows:

UPF: performing user data packet forwarding according to a routing rule of the SMF;

AUSF: performing UE security authentication;

AMF: performing UE access and mobility management;

SMF: performing UE session management;

NSSF: selecting a network slice for the UE;

NEF: opening up a network function for a third party in a manner of an API;

NRF: providing a storage function and a selection function of network functional entity information for other network elements;

UDM: subscribing context management with users;

PCF: managing policies of users;

AF: managing applications of users.

In the architecture shown in FIG. 2, interface N1 is a reference point between the UE and the AMF. Interface N2 is a reference point of the RAN and the AMF, and is used for sending an NAS message and the like. Interface N3 is a reference point between the RAN and the UPF, and is used for transmitting data of the user plane and the like. Interface N4 is a reference point between the SMF and the UPF, and is used for transmitting information such as tunnel identifier information of N3 connection, data cache indication information, and a downlink data notification message. Interface N6 is a reference point between the UPF and the DN, and is used for transmitting data of the user plane. Interface NG: It is an interface between the radio access network and the 5G core.

The names of the interfaces between the respective network elements in FIG. 1 and FIG. 2 are just an example, and the names of the interfaces in a specific implementation may be other names, which are not specifically limited in this embodiment of this disclosure. The names of the various network elements (such as the SMF, the AF, and the UPF) included in FIG. 1 and FIG. 2 are also only an example, and do not limit the functions of the network elements. In 5GS and other future networks, the above-mentioned network elements may also have other names, which are not specifically limited in this embodiment of this disclosure. For example, in a 6G network, some or all of the above-mentioned network elements may use the terms in 5G, and may also use other names, and the like, which will be uniformly described here and will not be repeated below. In addition, it is understood that names of messages (or signals) transmitted between the various network elements are also only an example, and do not constitute any limitation to the functions of the messages.

The above network elements may be implemented by a physical server, or may be implemented by a container or a virtual machine in a virtualization platform, and this disclosure does not limit the physical forms or logical forms of the above network elements.

FIG. 3 shows a schematic diagram of an application scenario of a network slice provided according to one exemplary embodiment of this disclosure. A third-party Service Provider (SP) subscribes three network slices from the MNO: network slice #1, network slice #2, and network slice #3. Network slice #1 is used for providing online video services; network slice #2 is used for providing game services; and network slice #3 is used for providing Internet surfing, chatting and downloading services. Network slice #1 and network slice #2 are specially used for providing network slices with specific QoS guarantees.

User A uses a business provided by the third-party SP through UE1, and user B uses a business provided by the third-party SP through UE2. User A and User B can be ordinary members or senior members of the third-party SP. If a user is an ordinary member, the user can only access the 5G network and be served through network slice #3. An ordinary member can still click online games or online videos, but the QoS cannot be guaranteed. For example, it is difficult for users to obtain a better user experience only through network slicing #3 in services such as a cloud game with a large latency and big bandwidth and a high-resolution 4K video. Therefore, this disclosure provides an embodiment in which a third-party server controls the UE to access which network slices.

The third-party SP refers to service providers that are independent of users and mobile network operators. For example, the third-party SP is a service provider that provides an instant messaging service, a service provider that provides a downloading service, a service provider that provides a web browsing service, a service provider that provides an e-commerce service, a service provider that provides a game service, and the like. The third-party SP may be referred to as a third party, and a server deployed, leased or used by the third-party SP may be referred to as a third-party server. The network element used by the third-party SP may be the AF. A media service provided by third-party SP is a third-party service, or a third-party application, or a third-party business, or business.

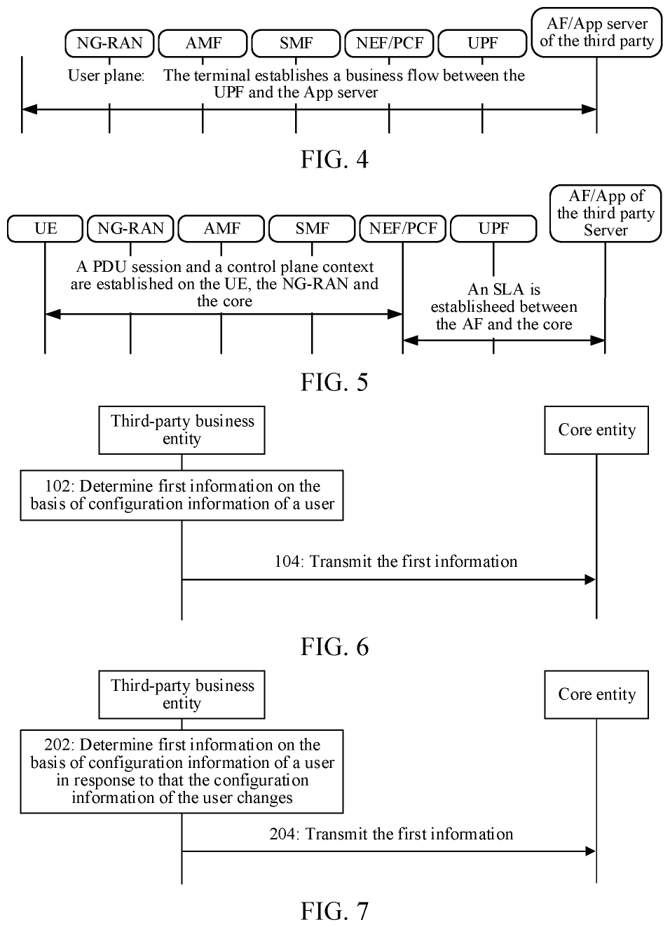

The control plane and the user plane in the 5G network system are separated. FIG. 4 shows a schematic diagram of a user plane provided according to another exemplary embodiment of this disclosure. The UE establishes a business flow with a third-party AF or APP server through the UPF in the core, and the business flow may be carried by one or more QoS flows. There may be multiple APPs on the same UE, and these APPs access the same or different network slices.

FIG. 5 shows a schematic diagram of a control plane provided according to one exemplary embodiment of this disclosure. A PDU session and a control plane context are established on the UE, the NG-RAN and the core entity, and a Service Level Agreement (SLA) is established between the third-party AF and the core entity. This SLA includes: relevant SLA agreements of network slice #1, network slice #2 and network slice #3, such as QoS parameters, charging rules, and related information such as time and position.

FIG. 6 shows a flow chart of a network slice selection method provided according to one exemplary embodiment of this disclosure. This embodiment is described by applying the method to a third-party business entity. The method includes the following steps.

Step 102: The third-party business entity determines first information on the basis of configuration information of a user.

The configuration information is configuration information of the user in the third-party business entity. Illustratively, a user is usually identified by a user account, and the same user may use one or more sets of UE. The configuration information is information related to at least one of an identity type of the user, a membership level, a billing manner, permission, a geographic position, and time period.

Step 104: The third-party business entity transmits the first information to a core entity.

The first information is used for selecting a first network slice corresponding to a third-party business of the user from at least two network slices. The first network slice may be considered as a better network slice corresponding to the third-party business of the user, or the best network slice corresponding to the third-party business of the user.

The at least two network slices are used for providing different QoSs. Illustratively, for the same type of business, at least two network slices are used for providing different QoSs. A business of video playing is taken as an example. At least two network slices are used for providing playing quality of normal resolution, high-definition resolution, and ultra-high-definition resolution, respectively.

In an embodiment, the at least two network slices are also used for providing different types of businesses. For example, network slice #1 provides business A and business B, and network slice #2 provides business A, business B, and business C, wherein business C is an exclusive business for VIP users.

The first information includes: at least one of the QoS demand information of the third-party business, a slice identifier of the first network slice, a slice precedence, and a business precedence. This disclosure does not limit the specific content of the first information, as long as the first information can assist the core entity to select a better network entity for the third-party business of the user.

The above-mentioned third-party business entity may be the AF shown in FIG. 2. The above-mentioned core entity may be an entity with a policy control function, such as the PCF shown in FIG. 2.

In conclusion, according to the method provided by this embodiment, the first information is determined through the third-party business entity on the basis of the configuration information of the user; the first information is transmitted to the core entity; and the core entity selects the first network slice corresponding to the third-party business of the user from at least two network slices, so that the third-party business entity can actively control the network slice accessed by the UE. A network slice management mechanism friendly to a third party is provided, so that the third party can interact with the core entity on the basis of the configuration information of the user to determine the first network slice, and the first network slice is used to flexibly provide different QoS businesses for the user; and the network slice management flexibility is improved.

FIG. 7 shows a flow chart of a network slice selection method provided according to one exemplary embodiment of this disclosure. This embodiment is described by applying the method to a third-party business entity. The method includes the following steps.

Step 202: The third-party business entity determines first information on the basis of configuration information of a user in response to that the configuration information of the user changes. For example, in response to an update in configuration information of a user of a media service, first information indicating updated configuration information of the user of the media service is determined. The first information indicates an updated selection of a first network slice from at least two network slices.

The configuration information is configuration information of the user in the third-party business entity or a third-party server. Illustratively, a user is usually identified by a user account, and the same user may use one or more sets of UE. The configuration information is information related to at least one of an identity type of the user, a membership level, a billing manner, permission, a geographic position, and time period. The configuration information may also be referred to as attribute information, user information, personal information, personalized information, or other names.

Step 204: The third-party business entity transmits the first information to a core entity. For example, in response to the update in configuration information of the user of the media service, the media service transmits the first information to an entity of a 5G Core network.

The first information is used for selecting a first network slice corresponding to a third-party business of the user from at least two network slices. In some embodiments, the first network slice may be considered as a better network slice corresponding to the third-party business of the user, or the best network slice corresponding to the third-party business of the user.

The at least two network slices are used for providing different QoSs. In an embodiment, the at least two network slices are also used for providing different types of businesses.

In an illustrative example, the third-party business entity determines, in response to that the configuration information of the user changes, the first information on the basis of the configuration information of the user, and transmits the first information to the core entity. The configuration information is configuration information of the user in the third-party business entity. A user is usually identified by a user account, and the same user may use one or more sets of UE. The configuration information is information related to at least one of an identity type of the user, a membership level, a billing manner, permission, a geographic position, and time period.

The fact that the configuration information of the user changes includes at least one of the following cases:

A User Identity of the User Changes from a Nonmember Status to a Member Status:

In one embodiment, the third-party business entity sends the first information to the core entity in response to that the user identity of the user changes from the nonmember status to the member status. A service provider serving as a third party that provides video website A is taken as an example. The user can acquire a membership on video website A and change his or her user identity from a nonmember status to a member status. Ways to acquire a membership include but are not limited to: buying a membership, exchanging a membership with credits, exchange a membership with exchange codes, obtaining a membership as a gift, being bundled with other memberships, etc.

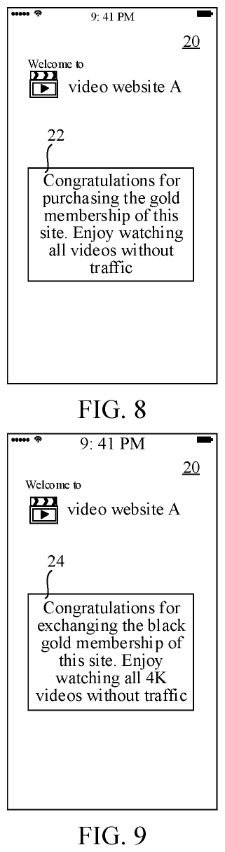

Illustratively referring to FIG. 8, the user buys a gold membership of video website A on page 20 of video website A, thereby changing the status from the nonmember status to the member status. Prompt information 22 pops out and is displayed on the page of video web site A: “Congratulations for purchasing the gold membership of this site. Enjoy watching all videos without traffic”.

A Membership Level of the User Changes from a First Level to a Second Level:

The second level is better than the first level, or the second level is worse than the first level.

In one embodiment, the third-party business entity sends the first information to the core entity in response to that the membership level of the user changes from the first level to the second level. A service provider serving as a third party that provides video website A is taken as an example. A user can acquire a membership on video website A and change his or her user identity from a gold membership to a platinum membership. The platinum membership is better than the gold membership. Ways to acquire a platinum membership include but are not limited to: buying a membership, exchanging a membership with credits, exchange a membership with exchange codes, obtaining a membership as a gift, being bundled with other memberships, etc.

Illustratively referring to FIG. 9, the user acquires a black gold membership of video website A on page 20 of video website A by exchange with exchange codes. Prompt information 24 pops out and is displayed on the page of video web site A: “Congratulations for exchanging the black gold membership of this site. Enjoy watching all 4K videos without traffic”.

The User Obtains a Service Trial Permission of a First Duration.

The service trial permission is a permission to try out a first service within the first duration.

The User Obtains a Service Reward Permission of a Second Duration.

The service reward permission is a permission to use a second service within the second duration.

The Third-Party Business of the User Belongs to a Specified Business Type.

The specific business type is a certain kind or several kinds of businesses pre-specified by the third-party business entity or the third-party SP. For example, the third-party business entity provides an online conference service which is a certain kind or several kinds of businesses pre-specified by the third-party business entity. When the third-party business of the user is the online meeting service, it belongs to the specified business type. The specified business type may also be referred to as a particular business type.

A Geographic Position where a Terminal Corresponding to the User is Located is Positioned in a Predetermined Region.

The predetermined region is one or more geographic regions pre-specified by the third-party business entity or third-party SP. For example, the predetermined region is a region where a certain game competition venue is located. When a game business is accessed to this venue, a network performance guarantee of higher quality will be preferentially obtained.

The Current Time Falls within a Predetermined Time Period.

The predetermined time period is one or more time periods pre-specified by the third-party business entity or the third-party SP, such as holidays, anniversaries, and user birthdays.

For example, the game business provides all users with highest-quality game services with unlimited traffic and unlimited levels for free within 24 hours of the anniversary celebration. If any user accesses the game business within 24 hours of the anniversary celebration, the third-party business entity sends the first information to the core entity. Alternatively, the third-party business entity sends the first information to the core entity before the anniversary, the first information being applicable to all users of the game business.

The various above cases can also be freely combined, which is not limited in this disclosure.

In conclusion, in the method provided in this embodiment, when the configuration information of the user changes, the third-party business entity sends the first information to the core entity, so that the third-party business entity can use the first network slice to provide higher QoS to the user when the user buys the membership service, upgrades the membership level, changes the use permission and the like.

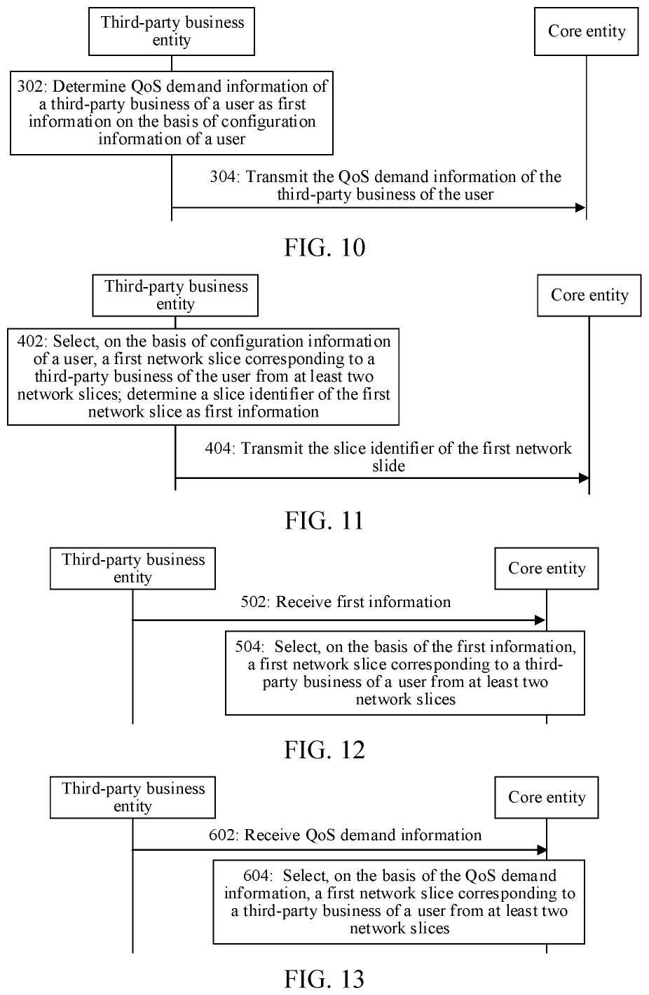

FIG. 10 shows a flow chart of a network slice selection method provided according to one exemplary embodiment of this disclosure. This embodiment is described by applying the method to a third-party business entity. The method includes the following steps.

Step 302: The third-party business entity determines QoS demand information (QoS requirement information) of a third-party business (media service) of a user as first information on the basis of the configuration information of the user.

Step 304: The third-party business entity transmits the QoS demand information of the third-party business of the user to a core entity.

In this embodiment, the third-party business entity does not need to care about the network slice selection process. The network slice selection process is performed by the core entity according to the QoS demand information. That is, the QoS demand information is used for the core entity to select the first network slice corresponding to the third-party business of the user from the at least two network slices. The QoS demand information may also be referred to as QoS demand.

In one design, when the user starts to use the third-party business, the third-party business entity sends the QoS demand information of the third-party business of the user to the core entity. In another design, when the configuration information of the user changes, the QoS demand information of the third-party business of the user changes, and the third-party business entity sends the QoS demand information of the third-party business of the user to the core entity. The QoS demand information is new QoS demand information or updated QoS demand information.

In an embodiment, the QoS demand information includes: at least one of an end-to-end latency, a jitter rate, a throughput, and a packet loss rate. This disclosure does not limit the specific content of the QoS demand information.

The at least two network slices are used for providing different QoSs. At least two network slices provide different QoSs. The core entity selects the first network slice corresponding to the third-party business of the user according to the QoS demand information of the third-party business. The first network slice is a better network slice or the best network slice that can satisfy the QoS demand information. The QoS demand information is used for selecting the first network slice corresponding to the third-party business of the user from the at least two network slices.

In an embodiment, the third-party business entity also sends identifier information to the core entity. The identifier information includes: at least one of an identifier of the user, an identifier of UE used by the user, triple or quintuple information of a PDU session of the UE, an IP address of the UE, a PDU session identifier, and a QoS flow identifier, so that the core entity can determine the QoS flow to which a business flow of the third-party business of the user belongs.

In an embodiment, the above-mentioned QoS demand information is based on per QoS flow. For each terminal in a connected state, there is one or more corresponding PDU sessions, and each PDU session will have one or more corresponding QoS flows and data radio bearers. An IP packet is mapped onto the QoS flow on the basis of a QoS request. These requests can be requirements for latency or requirements for desired data rates. Each data packet can be labeled with a QoS Flow Identifier (QFI).

When the UE corresponds to multiple QoS flows, the above-mentioned QoS demand information may be sent for a single QoS granularity. For example, the first QoS flow carries a game business; the second QoS flow carries a video business; and the third-party business entity sends the QoS demand information of the first QoS flow to the core entity.

In another possible design, the above-mentioned QoS demand information may be replaced by a slice precedence or a business precedence, which will not be repeated herein.

In conclusion, in the method provided in this embodiment, the third-party business entity sends the QoS demand information of the third-party business of the user to the core entity, without concerning about the network slice selection process, which simplifies the implementation logic of the third-party business entity, also enables the third party to flexibly provide different QoS businesses for the user, and simplifies the complexity of interaction between the third party and the mobile network operator.

FIG. 11 shows a flow chart of a network slice selection method provided according to one exemplary embodiment of this disclosure. This embodiment is described by applying the method to a third-party business entity. The method includes the following steps.

Step 402: The third-party business entity selects, on the basis of the configuration information of the user, the first network slice corresponding to the third-party business of the user from the at least two network slices; and determines a slice identifier of the first network slice as the first information.

In this embodiment, the third-party business entity performs a network slice selection process.

In one design, when the user starts to use the third-party business, the third-party business entity selects the first network slice corresponding to the third-party business of the user. For example, the third-party business entity selects, according to the QoS demand of the third-party business of the user, the first network slice corresponding to the third-party business of the user from the at least two network slices. The at least two network slices are network slices subscribed between the third-party business entity and the core entity and are used for providing different QoSs.

In another design, when the configuration information of the user changes, the QoS demand information of the third-party business of the user changes, and the third-party business entity selects the first network slice corresponding to the third-party business of the user. For example, the third-party business entity selects, according to the QoS demand information, the first network slice corresponding to the third-party business of the user from the at least two network slices. The QoS demand information is new QoS demand information or updated QoS demand information.

In an embodiment, the first network slice is a better network slice or the best network slice that satisfies the QoS demand information.

In an embodiment, the QoS demand information includes: at least one of an end-to-end latency, a jitter rate, a throughput, and a packet loss rate. This disclosure does not limit the specific content of the QoS demand information.

Step 404: the third-party business entity transmits the slice identifier of the first network slice to the core entity.

The slice identifier is used for the core entity to select the first network slice corresponding to the third-party business of the user from the at least two network slices. In some embodiments, the slice identifier may be represented by Network Slice Selection Assistance Information (NSSAI), and one piece of NSSAI includes one or more Data Network Names (DNNs). In some other embodiments, the slice identifier is represented by an identifier for renaming the network slice by a third-party SP, which is not limited in this embodiment of this disclosure.

In an embodiment, the third-party business entity also sends identifier information to the core entity. The identifier information includes: at least one of an identifier of the user, an identifier of UE used by the user, triple or quintuple information of a PDU session of the UE, an IP address of the UE, a PDU session identifier, and a QoS flow identifier, so that the core entity can determine the QoS flow to which a business flow of the third-party business of the user belongs.

In an embodiment, the above-mentioned slice identifier is based on per QoS flow. When the UE corresponds to multiple QoS flows, the above-mentioned slice identifier may be sent for a single QoS granularity.

In conclusion, according to the method provided by this embodiment, the slice identifier of the first network slice is transmitted to the core entity through the third-party business entity, and the third-party business entity actively completes the network slice selection process, which simplifies the implementation logic of the core entity, so that the third party can interact with the core entity on the basis of the configuration information of the user to determine the first network slice, and the first network slice is used to flexibly provide different QoS business for users, and the network slice management flexibility is improved.

FIG. 12 shows a flow chart of a network slice selection method provided according to one exemplary embodiment of this disclosure. This embodiment is described by applying the method to a core entity. The method includes the following steps.

Step 502: The core entity receives first information transmitted by a third-party business entity. For example, an entity of a 5G Core network receives first information transmitted by a media service, the first information being determined by the media service according to updated configuration information of a user of the media service.

The first information is information used for the core entity to select a first network slice corresponding to a third-party business of a user from at least two network slices. The first information includes: at least one of QoS demand information of the third-party business of the user, a slice identifier of the first network slice, a slice precedence of the third-party business of the user, and a business precedence of the third-party business of the user. This disclosure does not limit the specific content of the first information, as long as the first information can assist the core entity to select a better network entity for the third-party business of the user.

In an embodiment, the first information is based on per QoS flow.

The first information is determined by the third-party business entity according to configuration information of the user. The configuration information is configuration information of the user in the third-party business entity. A user is usually identified by a user account, and the same user may use one or more sets of UE. The configuration information is information related to at least one of an identity type of the user, a membership level, a billing manner, permission, a geographic position, and time period. In an embodiment, the first information is sent by the third-party business entity in a case that the configuration information of the user changes. The fact that the configuration information of the user changes includes at least one of the following cases:

A user identity of the user changes from a nonmember status to a member status:

A membership level of the user changes from a first level to a second level:

The user obtains a service trial permission of a first duration.

The user obtains a service reward permission of a second duration.

The third-party business of the user belongs to a specified business type.

A geographic position where a terminal corresponding to the user is located is positioned in a predetermined region.

The current time falls within a predetermined time period.

In an embodiment, the core entity also receives identifier information transmitted by the third-party business entity, and the identifier information includes: at least one of an identifier of the user, an identifier of UE used by the user, triple or quintuple information of a PDU session of the UE, an IP address of the UE, a PDU session identifier, and a QoS flow identifier, so that the core entity can determine the QoS flow to which a business flow of the third-party business of the user belongs.

The identifier information and the first information may be synchronously or asynchronously transmitted. For example, the identifier information and the first information are carried in the same signal and transmitted, or carried in two adjacent signals and transmitted, or carried in two associated signals and transmitted.

An interaction signal for carrying the identifier information and the first information includes, but is not limited to, an interaction signal between an AF and a 5G core network element, and the 5G core network element includes, but is not limited to, a PCF and an NEF. The interaction signal may be based on a servitization architecture-based or interface-based manner, that is, an N5 or N33 interface.

Step 504: The core entity selects, on the basis of the first information, a first network slice corresponding to a third-party business of the user from at least two network slices. For example, the entity of the 5G Core network selects, based on the first information, a first network slice for providing the media service to the user from at least two network slices.

In conclusion, according to the method provided by this embodiment, the first information is determined through the third-party business entity on the basis of the configuration information of the user; the first information is transmitted to the core entity; and the core entity selects the first network slice corresponding to the third-party business of the user from at least two network slices, so that the third-party business entity can actively control the network slice accessed by the UE. A network slice management mechanism friendly to a third party is provided. Therefore, the third party can interact with the core entity on the basis of the configuration information of the user to determine the first network slice, and the first network slice is used to flexibly provide different QoS businesses for the user; and the network slice management flexibility is improved.

FIG. 13 shows a flow chart of a network slice selection method provided according to one exemplary embodiment of this disclosure. This embodiment is described by applying the method to a core entity. The method includes the following steps.

Step 602: The core entity receives QoS demand information transmitted by a third-party business entity.

The QoS demand information is used for the core entity to select the first network slice corresponding to the third-party business of the user from the at least two network slices. In an embodiment, the QoS demand information includes: at least one of an end-to-end latency, a jitter rate, a throughput, and a packet loss rate. This disclosure does not limit the specific content of the QoS demand information.

In an embodiment, the QoS demand information is based on per QoS flow.

In an embodiment the QoS demand information is sent by the third-party business entity in a case that the configuration information of the user changes. The fact that the configuration information of the user changes includes at least one of the following cases:

A user identity of the user changes from a nonmember status to a member status:

A membership level of the user changes from a first level to a second level:

The user obtains a service trial permission of a first duration.

The user obtains a service reward permission of a second duration.

The third-party business of the user belongs to a specified business type.

A geographic position where a terminal corresponding to the user is located is positioned in a predetermined region.

The current time falls within a predetermined time period.

Step 604: The core entity selects, on the basis of the QoS demand information, a first network slice corresponding to a third-party business of the user from at least two network slices.

The at least two network slices are used for providing different QoSs. At least two network slices provide different QoSs. The core entity selects the first network slice corresponding to the third-party business of the user according to the QoS demand information of the third-party business. The first network slice is a better network slice or the best network slice that can satisfy the QoS demand information among at least two network slice.

In conclusion, according to the method provided by this embodiment, the third-party business entity sends the QoS demand information of the third-party business of the user to the core entity, without concerning about the network slice selection process, which simplifies the implementation logic of the third-party business entity, so that the third party can interact with the core entity on the basis of the configuration information of the user to determine the first network slice, and the first network slice is used to flexibly provide different QoS business for users, and the network slice management flexibility is improved.

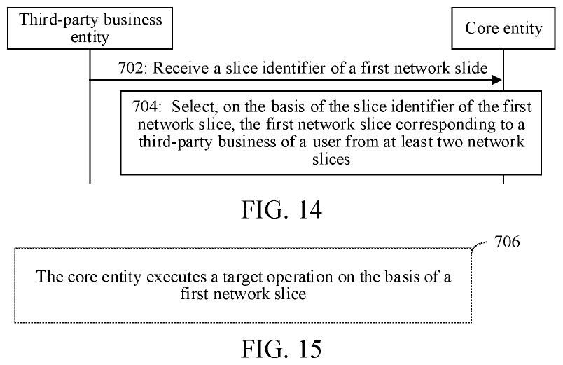

FIG. 14 shows a flow chart of a network slice selection method provided according to one exemplary embodiment of this disclosure. This embodiment is described by applying the method to a core entity. The method includes the following steps.

Step 702: The core entity receives a slice identifier of a first network slice transmitted by a third-party business entity.

The slice identifier is used for the core entity to select the first network slice corresponding to the third-party business of the user from the at least two network slices.

In an embodiment, the slice identifier of the first network slice is based on per QoS flow.

In an embodiment, the slice identifier of the first network slice is sent by the third-party business entity in a case that the configuration information of the user changes. The fact that the configuration information of the user changes includes at least one of the following cases:

A user identity of the user changes from a nonmember status to a member status:

A membership level of the user changes from a first level to a second level:

The user obtains a service trial permission of a first duration.

The user obtains a service reward permission of a second duration.

The third-party business of the user belongs to a specified business type.

A geographic position where a terminal corresponding to the user is located is positioned in a predetermined region.

The current time falls within a predetermined time period.

Step 704: The core entity selects, on the basis of the slice identifier, the first network slice corresponding to the third-party business of the user from the at least two network slices.

The at least two network slices are used for providing different QoSs. At least two network slices provide different QoSs. The core entity selects the first network slice corresponding to the third-party business of the user according to the slice identifier. The first network slice is a better network slice or the best network slice that can satisfy the slice identifier of the first network slice among at least two network slices.

In conclusion, according to the method provided by this embodiment, the slice identifier of the first network slice is transmitted to the core entity through the third-party business entity, and the third-party business entity actively completes the network slice selection process, which simplifies the implementation logic of the core entity, so that the third party can interact with the core entity on the basis of the configuration information of the user to determine the first network slice, and the first network slice is used to flexibly provide different QoS business for users, and the network slice management flexibility is improved.

FIG. 15 shows a flow chart of a network slice selection method provided according to one exemplary embodiment of this disclosure. This embodiment is described by applying the method to a core entity. The method includes the following steps.

Step 706: The core entity executes a target operation on the basis of a first network slice.

The first network slice is determined by the core entity on the basis of first information of a third-party business entity. The target operation includes a control plane operation required by a third-party business of a user to use the first network slice.

Assuming that the third-party business of the user uses a second network slice to provide a service before using the first network slice, the core entity executes the target operation on the basis of the first network slice in a case that the second network slice is switched to the first network slice.

For a terminal corresponding to the user, that is, a UE used by the user, the core entity performs the target operation on the basis of the first network slice, including at least one of the following:

updating, by the core entity, a policy of a terminal on the basis of the first network slice;

updating, by the core entity, a URSP rule of the terminal on the basis of the first network slice;

updating, by the core entity, a session policy of the terminal on the basis of the first network slice;

updating, by the core entity, an access and mobility management policy of the terminal on the basis of the first network slice;

in a case that the first network slice and a second network slice correspond to a same access network device, the access and mobility management policy includes: reconfiguring a radio bearer of the terminal; and

in a case that the first network slice and the second network slice correspond to different access network devices, the access and mobility management policy includes: triggering the terminal to perform a Hand Over (HO) process.

In conclusion, according to the method provided by this embodiment, the core entity executes the target operation on the basis of the first network slice, which can update related configurations of the core side in real time, so that the third-party business of the user successfully uses the first network slice to obtain different QoSs.

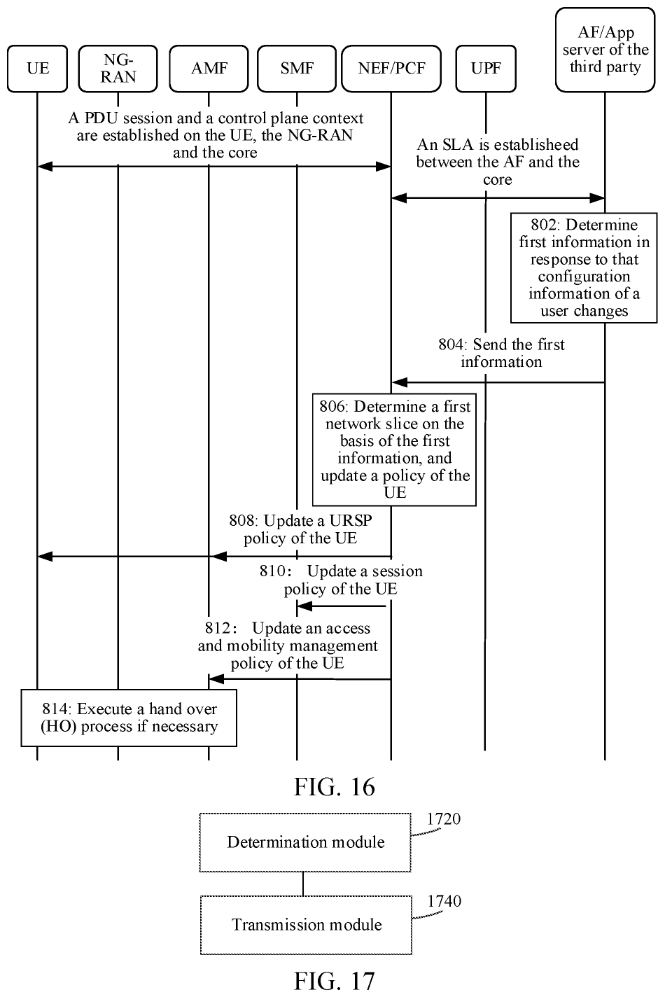

FIG. 16 shows a flow chart of a network slice selection method provided according to one exemplary embodiment of this disclosure. This embodiment is described by applying the method to the communication system shown in FIG. 2. The method includes the following steps.

Step 802: The AF determines first information in response to that configuration information of a user changes.

The first information is used for selecting a first network slice corresponding to a third-party business of the user from at least two network slices. The first network slice may be considered as a better network slice corresponding to the third-party business of the user, or the best network slice corresponding to the third-party business of the user.

The at least two network slices are used for providing different QoSs.

The first information includes: at least one of the QoS demand information of the third-party business, a slice identifier of the first network slice, a slice precedence, and a business precedence.

Step 804: The AF sends the first information to the PCF.

Step 806: The PCF determines a first network slice on the basis of the first information, and updates a policy of a UE.

The policy of the UE refers to a related policy required to be configured on a PCF entity when the UE uses the first network slice, such as PDU session-related parameters.

Step 808: The PCF, the AMF and the UE update a URSP policy of the UE.

The URSP policy refers to a related policy required to be configured on the AMF and the UE when the UE uses the first network slice. The PCF updates the URSP policy of the UE together with the AMF and the UE by means of a Non-Access Stratum (NAS), such as precedence parameters of the URSP rule.

Step 810: The PCF and the SMF update a session policy of the UE.

The session policy refers to a session policy required to be configured on the SMF when the UE uses the first network slice, such as a correspondence relationship between a business flow and a PDU session, and a correspondence relationship between a business flow and a QoS flow.

Step 812: The PCF and the AMF update the access and mobility management policy of the UE.

The access and mobility management policy refers to a session policy required to be configured on the AMF and the RAN when the UE uses the first network slice.

Assuming that the network slice used by the third-party service of the user needs to be switched from the second network slice to the first network slice:

in a case that the first network slice and a second network slice correspond to a same access network device, the access and mobility management policy includes: reconfiguring a radio bearer of the terminal; and

in a case that the first network slice and the second network slice correspond to different access network devices, the access and mobility management policy includes: triggering the terminal to perform an HO process.

Step 814: The UE is triggered to execute the HO process If necessary.

The HO process may be completed by the UE, a source access network device and a target access network device. Illustratively, the source access network device is a base station corresponding to the second network slice, and the target access network device is a base station corresponding to the first network slice.

In conclusion, according to the method provided by this embodiment, the first information is transmitted to the core entity, so that the core entity selects the first network slice corresponding to the third-party business of the user from at least two network slices, and the third-party business entity can actively control the network slice accessed by the UE. A network slice management mechanism friendly to a third party is provided, so that the third party can interact with the core entity on the basis of the configuration information of the user to determine the first network slice, and the first network slice is used to flexibly provide different QoS businesses for the user; and the network slice management flexibility is improved.

According to the method provided by this embodiment, the PCF executes the target operation on the basis of the first network slice, which can update related configurations of the core side in real time, so that the third-party business of the user successfully uses the first network slice to obtain different QoSs.

In the various above embodiments, the first information is transmitted by an API of the core entity opened (or available) to the third-party business entity.

The various foregoing embodiments may be implemented individually, or every two of the embodiments are combined for implementation, or several embodiments are combined for implementation. This is what those skilled in the art can easily think about based on the above description, and will not be repeated one by one.

FIG. 17 shows a block diagram of a network slice selection apparatus according to one exemplary embodiment of this disclosure, the apparatus including:

a determination module 1720, configured to determine first information on the basis of configuration information of a user, the first information being used for selecting a first network slice corresponding to a third-party business of the user from at least two network slices; and

a transmission module 1740, configured to transmit the first information to a core entity.

In an implementation of this embodiment, the determination module 1720 is configured to determine the first information on the basis of the configuration information of the user in response to that the configuration information of the user changes.

In an implementation of this embodiment, the fact that the configuration information of the user changes includes at least one of the following cases:

a user identity of the user changes from a nonmember status to a member status;

a membership level of the user changes from a first level to a second level;

the user obtains a service trial permission of a first duration;

the user obtains a service reward permission of a second duration;

the third-party business of the user belongs to a specified business type;

a geographic position where a terminal corresponding to the user is located is positioned in a predetermined region; and

the current time falls within a predetermined time period.

In an implementation of this embodiment, the determination module 1720 is configured to determine QoS demand information of the third-party business of the user as the first information on the basis of the configuration information of the user;

the transmission module 1740 is configured to transmit the QoS demand information of the third-party business of the user to the core entity so that the core entity selects, on the basis of the QoS demand information, the first network slice corresponding to the third-party business of the user from the at least two network slices.

In an implementation of this embodiment, the first information is based on per QoS flow.

In an implementation of this embodiment, the determination module 1720 is configured to select, on the basis of the configuration information of the user, the first network slice corresponding to the third-party business of the user from the at least two network slices; and determine a slice identifier of the first network slice as the first information; and

the transmission module 1740 is configured to transmit the slice identifier of the first network slice to the core entity so that the core entity determines, on the basis of the slice identifier, the first network slice corresponding to third-party business of the user from the at least two network slices.

In an implementation of this embodiment, the first information is transmitted by an API opened by the core entity.

In an implementation of this embodiment, the apparatus is applied to a third-party business entity, and the third-party business entity is an AF entity.

In an implementation of this embodiment, the core entity is a PCF entity.

In an implementation of this embodiment, the at least two network slices are used for providing different QoSs.

In conclusion, according to the apparatus provided by this embodiment, the first information is determined on the basis of the configuration information of the user; the first information is transmitted to the core entity; and the core entity selects the first network slice corresponding to the third-party business of the user from at least two network slices, so that the third-party business entity can actively control the network slice accessed by the UE. A network slice management mechanism friendly to a third party is provided, so that the third party can interact with the core entity on the basis of the configuration information of the user to determine the first network slice, and the first network slice is used to flexibly provide different QoS businesses for the user; and the network slice management flexibility is improved.

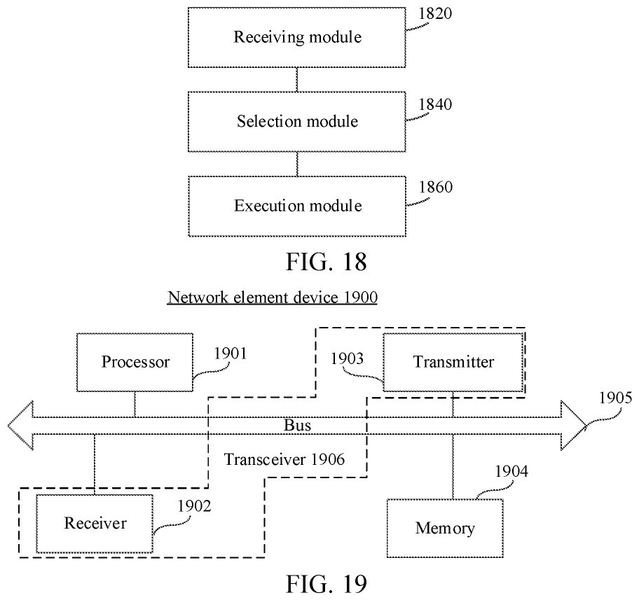

FIG. 18 shows a block diagram of a network slice selection apparatus according to one exemplary embodiment of this disclosure, the apparatus including:

a receiving module 1820, configured to receive first information transmitted by a third-party business entity, the first information being determined by the third-party business entity according to configuration information of a user; and

a selection module 1840, configured to select, on the basis of the first information, a first network slice corresponding to a third-party business of the user from at least two network slices.

In an implementation of this embodiment, the first information includes QoS demand information of the third-party business of the user;

the selection module 1840 is configured to select, on the basis of the QoS demand information of the third-party business of the user, the first network slice corresponding to the third-party business of the user from the at least two network slices.

In an implementation of this embodiment, the first information includes a slice identifier of the first network slice;

the selection module 1840 is configured to select, on the basis of the slice identifier, the first network slice corresponding to the third-party business of the user from the at least two network slices.

In an implementation of this embodiment, the apparatus further includes an execution module 1860; the execution module 1860 is configured to execute a target operation on the basis of the first network slice.

In an implementation of this embodiment, the execution module 1860 is configured to update a policy of a terminal on the basis of the first network slice, the terminal being a terminal corresponding to the user.

In an implementation of this embodiment, the execution module 1860 is configured to update a URSP policy of a terminal on the basis of the first network slice, the terminal being a terminal corresponding to the user.

In an implementation of this embodiment, the execution module 1860 is configured to update a session policy of a terminal on the basis of the first network slice, the terminal being a terminal corresponding to the user.

In an implementation of this embodiment, the execution module 1860 is configured to update an access and mobility management policy of a terminal on the basis of the first network slice, the terminal being a terminal corresponding to the user.

In an implementation of this embodiment, in a case that the first network slice and a second network slice correspond to a same access network device, the access and mobility management policy includes: reconfiguring a radio bearer of the terminal; and

in a case that the first network slice and the second network slice correspond to different access network devices, the access and mobility management policy includes: triggering the terminal to perform a hand over process.

In an implementation of this embodiment, the third-party business entity is an AF entity.

In an implementation of this embodiment, the apparatus is applied to a core entity, and the core entity is a PCF entity.

In an implementation of this embodiment, the at least two network slices are used for providing different QoSs.

In conclusion, in the apparatus provided in this embodiment, the first information is determined through the third-party business entity on the basis of the configuration information of the user; the first information is transmitted to the core entity; and the core entity selects the first network slice corresponding to the third-party business of the user from the at least two network slices, so that the third-party business entity can actively control a network slice accessed by a UE. A network slice management mechanism friendly to a third party is provided, so that the third party can flexibly provide different QoS businesses for the user on the basis of the configuration information of the user, and the complexity of interaction between the third party and a mobile network operator is simplified.

FIG. 19 shows a schematic structural diagram of a network element device 1900 provided by one embodiment of this disclosure. For example, the network element device can be configured to implement the above-mentioned network slice selection method. Specifically: The network element device 1900 may include: a processor 1901 (including processing circuitry), a receiver 1902, a transmitter 1903, a memory 1904 (including a non-transitory computer-readable storage medium), and a bus 1905.

The processor 1901 includes one or more processing cores, and the processor 1901 performs various functional applications and information processing by running a software program and module.

The receiver 1902 and the transmitter 1903 may be implemented as one transceiver 1906, and the transceiver 1906 may be a communication chip. The transceiver 1906 may be a wireless transceiver, an optical fiber transceiver, an RJ45 interface-based network transceiver, and the like.

The memory 1904 is connected to the processor 1901 through the bus 1905.

The memory 1904 may be configured to store computer programs, and the processor 1901 is configured to execute the computer programs to realize the various steps executed by the network element device in the above-mentioned method embodiment.

In an embodiment, a non-transitory computer-readable storage medium stores computer-readable instructions which, when executed by a computer device, cause the computer device to perform a network slice selection method. The method includes, in response to an update in configuration information of a user of a media service, determining first information indicating updated configuration information of the user of the media service. The first information indicates an updated selection of a first network slice from at least two network slices. The method further includes transmitting, by the media service, the first information to an entity of a 5G Core network.

In an embodiment, a non-transitory computer-readable storage medium stores computer-readable instructions which, when executed by a computer device, cause the computer device to perform a network slice selection method. The method includes receiving, by an entity of a 5G Core network, first information transmitted by a media service, the first information being determined by the media service according to updated configuration information of a user of the media service. The method further includes selecting, by the entity of the 5G Core network based on the first information, a first network slice for providing the media service to the user from at least two network slices.

In addition, the memory 1904 may be implemented by using any type of volatile or non-volatile storage devices or a combination thereof, and the volatile or non-volatile storage devices include, but not limited to: a random-access memory (RAM), a read-only memory (ROM), an erasable programmable ROM (EPROM), an electrically erasable programmable ROM (EEPROM), a flash memory or another solid-state memory technology, a compact disc read-only memory (CD-ROM), a digital versatile disc (DVD) or another optical memory, a tape cartridge, a magnetic cassette, a magnetic disk memory, or another magnetic storage device.

In an exemplary embodiment, a computer-readable storage medium is further provided, the computer-readable storage medium storing at least one piece of instruction, at least one program, a code set or an instruction set, and the at least one piece of instruction, the at least one program, the code set or the instruction set being loaded and executed by the processor to implement the network slice selection method performed by the third-party business entity or the core entity provided in the foregoing method embodiments.

This disclosure further provides a computer-readable storage medium, the storage medium storing at least one instruction, at least one program, a code set or an instruction set, and the at least one instruction, the at least one program, the code set or the instruction set being loaded and executed by the processor to implement the network slice selection method provided in the foregoing method embodiments.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. A network slice selection method, the method comprising:
in response to an update in configuration information of a user of a media service,
determining first information indicating updated configuration information of the user of the media service, the first information indicating an updated selection of a first network slice from at least two network slices; and
transmitting, by the media service, the first information to an entity of a 5G Core network.

2. The method according to claim 1, wherein the media service comprises one or more of an instant messaging service, a download service, a web browsing service, an e-commerce service, or a game service.

3. The method according to claim 1, wherein the update in the configuration information of the user of the media service comprises at least one of:
a user identity of the user changes from a nonmember status to a member status;
a membership level of the user changes from a first level to a second level;
the user obtains a service trial permission of a first duration;
the user obtains a service reward permission of a second duration;
the media service is a specified type of media service;
a geographic position where a terminal corresponding to the user is located is positioned in a predetermined region; or
a current time falls within a predetermined time period.

4. The method according to claim 1, wherein
the determining comprises:
determining, by the media service, Quality of Service (QoS) requirement information of the media service as the first information based on the updated configuration information of the user; and
the transmitting comprises:
transmitting, by the media service, the QoS requirement information of the media service to the entity of the 5G Core network so that the entity selects, based on the QoS requirement information, the first network slice for providing the media service to the user from the at least two network slices.

5. The method according to claim 1, wherein
the determining comprises:
selecting, by the media service based on the updated configuration information of the user, the first network slice from the at least two network slices; and
determining a slice identifier of the first network slice as the first information; and
the transmitting comprises:
transmitting, by the media service, the slice identifier of the first network slice to the entity of the 5G Core network so that the entity determines, based on the slice identifier, the first network slice for providing the media service to the user from the at least two network slices.

6. The method according to claim 1, wherein the first information is based on a QoS flow.

7. The method according to claim 1, wherein the first information is transmitted by an Application Programming Interface (API) of the entity of the 5G Core network available to the media service.

8. The method according to claim 1, wherein the media service is an Application Function (AF).

9. The method according to claim 1, wherein the entity of the 5G Core network is a Policy Control Function (PCF).

10. The method according to claim 1, wherein the at least two network slices provide different QoSs.

11. A network slice selection method, the method comprising:
receiving, by an entity of a 5G Core network, first information transmitted by a media service, the first information being determined by the media service according to updated configuration information of a user of the media service; and
selecting, by the entity of the 5G Core network based on the first information, a first network slice for providing the media service to the user from at least two network slices.

12. The method according to claim 11, wherein
the first information comprises QoS requirement information of the media service; and
the selecting comprises:
selecting, by the entity of the 5G Core network based on the QoS requirement information of the media service, the first network slice for providing the media service to the user from the at least two network slices.

13. The method according to claim 11, wherein
the first information comprises a slice identifier of the first network slice; and
the selecting comprises:
selecting, by the entity of the 5G Core network based on the slice identifier, the first network slice for providing the media service to the user from the at least two network slices.

14. The method according to claim 11, the method further comprising:
executing, by the entity of the 5G Core network, an operation based on the selected first network slice.

15. The method according to claim 14, wherein the executing comprises:
updating, by the entity of the 5G Core network, a policy corresponding to a terminal based on the selected first network slice, the terminal being a terminal of the user.

16. The method according to claim 14, wherein the executing comprises:
updating, by the entity of the 5G Core network, a user equipment routing selection policy (URSP) rule of a terminal based on the selected first network slice, the terminal being a terminal of the user.

17. The method according to claim 14, wherein the executing comprises:
updating, by the entity of the 5G Core network, a session policy of a terminal based on the determined first network slice, the terminal being a terminal of the user.

18. The method according to claim 14, wherein the executing, comprises:
updating, by the entity of the 5G Core network, an access and mobility management policy of a terminal based on the determined first network slice, the terminal being a terminal of the user.

19. The method according to claim 18, wherein
in response to a determination that the first network slice and a second network slice previously used by the terminal of the user correspond to a same access network device, the access and mobility management policy comprises reconfiguring a radio bearer of the terminal; and
in response to a determination that the first network slice and the second network slice correspond to different access network devices, the access and mobility management policy comprises triggering the terminal to perform a hand over process.

20. A network slice selection apparatus, comprising:
processing circuitry of a media service, the processing circuitry being configured to in response to an update in configuration information of a user of the media service,
determine first information indicating updated configuration information of the user of the media service, the first information indicating an updated selection of a first network slice from at least two network slices; and
transmit the first information to an entity of a 5G Core network.
